(19) United States
(12) Patent Application Publication
(10) Pub. No.: US 2026/0340873 A1
(43) Pub. Date: Oct. 29, 2026

(54) SYSTEMS AND METHODS FOR ESTIMATING CAMERA PARAMETERS USING IMAGE DATA

(71) Applicant: Toyota Research Institute, Inc., Los Altos, CA (US)

(72) Inventors: Jiahao Li, Chicago, IL (US); Haochen Wang, Chicago, IL (US); Igor Vasiljevic, San Mateo, CA (US); Matthew R. Walter, Chicago, IL (US); Vitor Campagnolo Guizilini, Santa Clara, CA (US); Gregory Shakhnarovich, Chicago, IL (US); Muhammad Zubair Irshad, Milpitas, CA (US)

(73) Assignees: Toyota Research Institute, Inc., Los Altos, CA (US); Toyota Jidosha Kabushiki Kaisha, Toyota-shi Aichi-ken (JP); Toyota Technological Institute at Chicago, Chicago, IL (US)

(21) Appl. No.: 19/306,164

(22) Filed: Aug. 21, 2025

Related U.S. Application Data
(60) Provisional application No. 63/796,749, filed on Apr. 29, 2025.

(51) Int. Cl. G06T 7/80; G06T 7/13; G06T 7/33

(52) U.S. Cl. CPC G06T 7/80; G06T 7/13; G06T 7/33; G06T 2207/30252

(57) ABSTRACT

Systems, methods, and other embodiments described herein relate to estimating camera parameters using a pipeline that computes camera intrinsics and extrinsics with image data while reducing complexity. In one embodiment, the method includes estimating intrinsic parameters for a camera from image data and deriving a distortion parameter and a focal length. The method also includes computing a global rotation alignment and a global translation alignment for the camera with the intrinsic parameters, an extracted relative rotation, and an extracted relative translation. The method also includes calculating an epipolar adjustment with generated matched point pairs and image pairs from the image data using track completion and the global translation alignment. The method also includes outputting the intrinsic parameters and camera poses associated with the epipolar adjustment.

### CROSS-REFERENCE TO RELATED APPLICATIONS

This application claims the benefit of U.S. Provisional Application No. 63/796,749, filed on Apr. 29, 2025, which is herein incorporated by reference in its entirety.

### TECHNICAL FIELD

The subject matter described herein relates, in general, to estimating camera parameters, and, more particularly, to estimating camera parameters using a pipeline that computes camera intrinsics and extrinsics with image data while reducing complexity.

### BACKGROUND

Electronic systems use image data from a camera for completing various tasks. For instance, electronic systems increasingly utilize image data for computer vision tasks, such as object recognition, depth estimation, and motion tracking. Applications including automated vehicles, robotics, augmented reality, etc., rely on these tasks where real-time visual input is processed to interpret and act within dynamic scenes. The accuracy and reliability of these tasks depend upon identifying camera features and image quality captured by the camera.

In various implementations, these tasks are affected by various forms of distortion and error, particularly when the camera and the scene are in motion. For example, motion blur, rolling shutter effects, geometric distortion, and temporal inconsistencies degrade image quality and hinder the performance of vision algorithms. These problems are exacerbated during high-speed or unstable conditions, leading to reduced accuracy in object detection, tracking, and spatial understanding. Addressing these challenges is demanded for increasing system reliability and expanding applications of these tasks in electronic systems.

### SUMMARY

In one embodiment, example systems and methods relate to estimating camera parameters using a pipeline that computes camera intrinsics and extrinsics with image data while reducing complexity. In various implementations, systems use structure from motion (SfM) to recover camera parameters and three-dimensional (3D) structure from image data. These systems can recover the 3D structure through triangulation and other techniques upon identifying camera poses. However, system performance can be lacking in dense and high-precision scenarios when processing vast images for maximizing accuracy. These systems can also exhibit subpar run-times when estimating camera parameters and poses having sub-degree accuracy, thereby hindering applications that rely upon precise specifications from the systems.

Therefore, in one embodiment, an estimation system derives global structure from motion of objects within a scene for predicting intrinsic parameters about a camera using a graphical processor unit (GPU) conducive operations that allow parallel processing, thereby increasing optimization speed. Here, the estimation system may derive global rotations with reduced complexity through a gradient descent on a geodesic distance between global and relative rotations. The pipeline also simplifies optimization of global translation (e.g., a camera location) directly from estimated relative translations by a gradient descent on normalized relative translation errors from random initialization that yields effective and robust translation estimates. In one approach, the estimation system optimizes translations with epipolar adjustment that generates matched point pairs and image pairs from the image data using track completion and the global translation alignment. Outputs of the estimation system can include the intrinsic parameters and camera poses derived with the epipolar adjustment. In this way, the estimation system involves optimization that is time linear with a number of image pairs and independent of 3D points that further improves speed through avoiding high-dimensional analysis while maintaining reliable scene reconstruction.

In one embodiment, an estimation system that estimates camera parameters using a pipeline that computes camera intrinsics and extrinsics with image data while reducing complexity is disclosed. The estimation system includes a memory having instructions that, when executed by a processor, cause the processor to estimate intrinsic parameters for a camera from image data and derive a distortion parameter and a focal length. The instructions also include instructions to compute a global rotation alignment and a global translation alignment for the camera with the intrinsic parameters, an extracted relative rotation, and an extracted relative translation. The instructions also include instructions to calculate an epipolar adjustment with generated matched point pairs and image pairs from the image data using track completion and the global translation alignment. The instructions also include instructions to output the intrinsic parameters and camera poses associated with the epipolar adjustment.

In one embodiment, a non-transitory computer-readable medium for estimating camera parameters using a pipeline that computes camera intrinsics and extrinsics with image data while reducing complexity and including instructions that when executed by a processor cause the processor to perform one or more functions is disclosed. The instructions include instructions to estimate intrinsic parameters for a camera from image data and derive a distortion parameter and a focal length. The instructions also include instructions to compute a global rotation alignment and a global translation alignment for the camera with the intrinsic parameters, an extracted relative rotation, and an extracted relative translation. The instructions also include instructions to calculate an epipolar adjustment with generated matched point pairs and image pairs from the image data using track completion and the global translation alignment. The instructions also include instructions to output the intrinsic parameters and camera poses associated with the epipolar adjustment.

In one embodiment, a method for estimating camera parameters using a pipeline that computes camera intrinsics and extrinsics with image data while reducing complexity is disclosed. In one embodiment, the method includes estimating intrinsic parameters for a camera from image data and derive a distortion parameter and a focal length. The method also includes computing a global rotation alignment and a global translation alignment for the camera with the intrinsic parameters, an extracted relative rotation, and an extracted relative translation. The method also includes calculating an epipolar adjustment with generated matched point pairs and image pairs from the image data using track completion and the global translation alignment. The method also includes outputting the intrinsic parameters and camera poses associated with the epipolar adjustment.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of an estimation system within which systems and methods disclosed herein may be implemented.

FIG. 2 illustrates one embodiment of a pipeline that is associated with estimating camera intrinsics and extrinsics with image data while reducing complexity.

FIG. 3 illustrates one example of a vehicle implementing the estimation system to predict intrinsic and extrinsic parameters about a camera.

FIG. 4 illustrates one embodiment of a method that is associated with estimating intrinsics and poses about a camera using global alignment, track completion, and epipolar adjustment.

### DETAILED DESCRIPTION

Systems, methods, and other embodiments associated with estimating camera parameters using a pipeline that computes camera intrinsics and extrinsics with image data while reducing complexity are disclosed herein. As previously explained, deriving structure from motion (SfM) using image data can involve complex operations (e.g., non-linear operations) that increase computational costs for a graphical processing unit (GPU) and other processors. Therefore, in one embodiment, an estimation system includes a pipeline that derives rapid, accurate, and dense SfM of a scene and predicts intrinsic and extrinsic camera parameters (e.g., pose) using computational iterations that are linear to image pairs. This avoids calculations involving three-dimensional (3D) points that increase GPU costs and delays. Furthermore, estimating camera parameters involves computing global rotation and translation alignment for a camera with the intrinsic parameters and extracted relative rotation and translation in a pipeline arrangement that reduces complexity.

In another implementation, the estimation system replaces bundle adjustment of data with the pipeline arrangement. For instance, the estimation system re-weights camera features through epipolar adjustments using matched point pairs and image pairs from the image data and track completion, thereby increasing efficiency. In this way, the pipeline can prioritize dense tensor operations (e.g., high-dimensional data) that harbor and promote GPU acceleration, thereby improving system efficiency and power usage.

It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

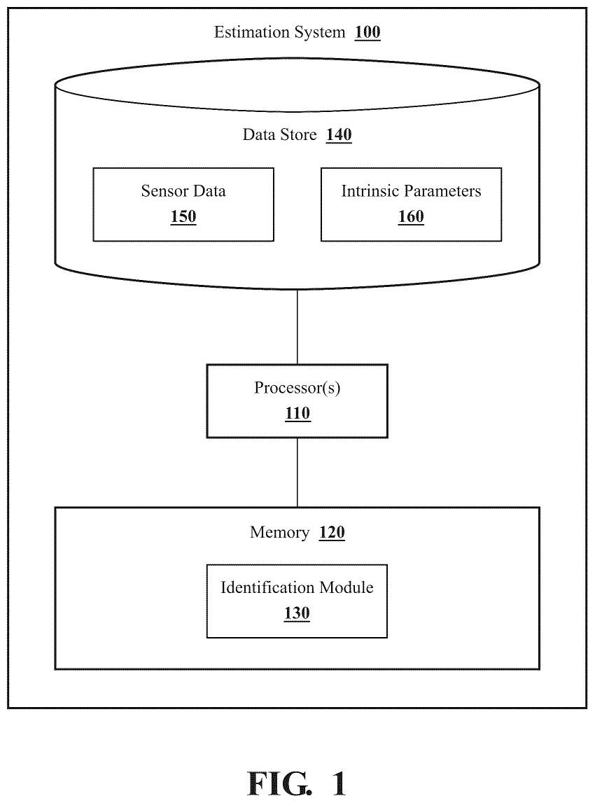

FIG. 1 illustrates one embodiment of an estimation system 100 within which systems and methods disclosed herein may be implemented. In one embodiment, the estimation system 100 includes a memory 120 that stores an identification module 130. The memory 120 is a random-access memory (RAM), a read-only memory (ROM), a hard-disk drive, a flash memory, or other suitable memory for storing the identification module 130. The identification module 130 is, for example, computer-readable instructions that when executed by the processor(s) 110 cause the processor(s) 110 to perform the various functions disclosed herein.

Moreover, in one embodiment, the estimation system 100 includes a data store 140. In one embodiment, the data store 140 is a database. The database is, in one embodiment, an electronic data structure stored in the memory 120 or another data store and that is configured with routines that can be executed by the processor(s) 110 for analyzing stored data, providing stored data, organizing stored data, and so on. Thus, in one embodiment, the data store 140 stores data used by the identification module 130 in executing various functions.

In another embodiment, the data store 140 includes the sensor data 150 along with, for example, metadata that characterize various aspects of the sensor data 150. For example, the metadata can include location coordinates (e.g., longitude and latitude), relative map coordinates or tile identifiers, time/date stamps from when the separate sensor data 150 was generated, and so on. Examples of the sensor data 150 include image data acquired from one or more cameras of a device, such as a vehicle, a consumer electronics device, a robot, etc. In one embodiment, the data store 140 further includes intrinsic parameters 160 that comprise one of the focal length, an optical center, a principal point, and a skew coefficient associated with the camera.

The estimation system 100 as illustrated in FIG. 1 can generally be an abstracted form of the estimation system 100 as may be implemented. In one approach, the estimation system 100 and/or the identification module 130 generally includes instructions that function to control the processor(s) 110 to estimate the intrinsic parameters 160 for a camera from image data (e.g., one or more images) to derive a distortion parameter and a focal length. Here, estimating the intrinsic parameters allows downstream systems to identify objects and other features of a scene, particularly when the camera is in motion. Furthermore, the estimation system 100 computes a global rotation alignment and a global translation alignment for the camera with the intrinsic parameters 160, an extracted relative rotation, and an extracted relative translation. For example, a global rotation alignment for a camera can involve estimating and applying a rotational transformation across image frames that align a camera orientation with another frame (e.g., a reference frame). Meanwhile, a global translation alignment for a camera can involve estimating and applying a shift (i.e., translation) in position across image frames that aligns a camera viewpoint with another frame (e.g., a reference frame). In one approach, the estimation system 100 derives the global rotation alignment using a singular value decomposition (SVD) of a rotation matrix column-by-column. Deriving the global translation alignment can involve adjusting relative translations between image pairs associated with the global rotation alignment and the complete graph.

Following alignment determinations, the estimation system 100 can also calculate epipolar adjustment with generated matched point pairs and image pairs from the image data using track completion and the global translation alignment. Here, a point pair refers to two corresponding keypoints in different images that represent the same physical point in the scene. An image pair is a pair of images captured from a camera having different viewpoints or times that the estimation system 100 can utilize for motion estimation. For instance, the estimation system 100 identifies corresponding features (e.g., keypoints) between the images and compute displacement that reveals motion vectors or camera pose changes.

A track can be a sequence of positions that a specific keypoint occupies across multiple frames from the image data. A keypoint can be a distinctive point in an image (e.g., a corner, an edge, an object part, etc.) that can reliably be detected and used for tasks like object recognition, tracking, and matching. Tracking helps analyze motion, structure, or behavior by following keypoint movement over time. Here, epipolar adjustment and/or tracking can jointly refine the focal length and the camera poses (e.g., extrinsic parameters). As such, the estimation system 100 and/or identification module 130 output accurate and fast camera poses and the intrinsic parameters associated with the epipolar adjustment while reducing optimization complexity and computational costs through avoiding computations over 3D points that are larger than camera poses. Furthermore, deriving intrinsic camera parameters prior to extrinsic camera parameters reduces computational costs and complexity. The estimation system 100 also achieves reduced computational costs through maintaining complexity that is linear to image pair quantities among the image data.

In an implementation, estimating the intrinsic parameters 160 involves undistorting keypoints derived from the image data using an estimate of the distortion parameter from a geometric model. Here, the geometric model utilizes interval searching that includes hierarchical sampling for the distortion parameter. This allows accurately predicting the focal length using an essential matrix derived from interval sampling. An essential matrix can be a matrix that encapsulates the relative rotation and translation between two calibrated cameras and defines epipolar geometry of an image pair.

The estimation system 100 can transform the keypoints, the fundamental matrix, and the homography matrix with the intrinsic parameters 160 for identifying camera parameters. A fundamental matrix can be a matrix that relates corresponding points in a pair of uncalibrated images by encoding the epipolar geometry between the images. This matrix can map a point in one image to a corresponding epipolar line in the other, enabling constraints for feature matching and 3D scene reconstruction. A homogeneous matrix can be a transformation matrix used in projective geometry that allows for the representation of translation, rotation, scaling, and perspective transformations using homogeneous coordinates. This matrix can extend a standard transformation matrix to a higher dimension (e.g., 3×3 for two-dimensional (2D) or 4×4 for 3D) to handle this operation using matrix multiplication.

Moreover, calculating the epipolar adjustment can involve re-weighting the camera poses using a least squares function with the point pair and a L2 loss. For instance, an L2 loss is a loss function involving a mean squared error (MSE) that measures the average squared difference between predicted and actual values, penalizing larger errors more heavily. Here, the L2 loss is associated with previous values of the focal length and the camera poses. In one approach, the estimation system 100 computes an epipolar error for a point pair and weights the L2 loss with the epipolar error to efficiently derive a L1 loss when identifying camera parameters. For instance, a L1 loss is a loss function that involving a mean absolute error (MAE) that measures the average absolute difference between predicted and actual values. This makes the L1 loss more robust to prediction outliers than a L2 loss.

As further explained below, identifying parameters of one or more cameras can include the estimation system 100 extracting keypoints from the image data. Here, the keypoints identify features of an object within the image data, such as one of corners and edges. The estimation system 100 can match the keypoints to derive keypoint pairs and a matrix for an image pair from the image data. For instance, the matrix is one of an estimated fundamental matrix and a homography matrix about the image pair. In certain examples, keypoint and image pairs for a camera refer corresponding keypoints and data detected by the estimation system 100 in two or more images captured from different viewpoints. These pairs enable the estimation of camera motion or 3D scene structure by analyzing shifts among keypoints across images. This also allows the estimation system 100 to efficiently predict extrinsic camera parameters with the intrinsic parameters, the keypoint pairs, and the matrix, where the extrinsic camera parameters are camera poses that include a 3D rotation matrix and a 3D translation vector associated with the camera.

Regarding track completion, the estimation system 100 can generate new matched point pairs and image pairs for global translation and epipolar adjustments. Point pairs can be corresponding 2D points in multiple images (e.g., two) that represent the same 3D scene point. This allows estimating a geometric relationship between one or more cameras or a camera-in-motion in 2D rather than 3D, thereby reducing computational complexity. Image pairs can refer to multiple images (e.g., two) taken from different viewpoints. In this example, point correspondences are identified to compute camera parameters like relative pose and intrinsic and extrinsic matrices.

Moreover, track completion can be a task that converts tracks to multiple matches using pairwise combinations of the keypoints associated with a first track. Here, the keypoints are 2D keypoints and the multiple matches are associated with a 3D scene point in multiple images that are different. A pairwise combination for keypoint tracking can be a comparison and association of keypoints between consecutive frames to identify track motion. In one approach, the track completion also involves assembling a complete graph with the 2D keypoints. For instance, nodes of the complete graph are the 2D keypoints and edges are the multiple matches among different images.

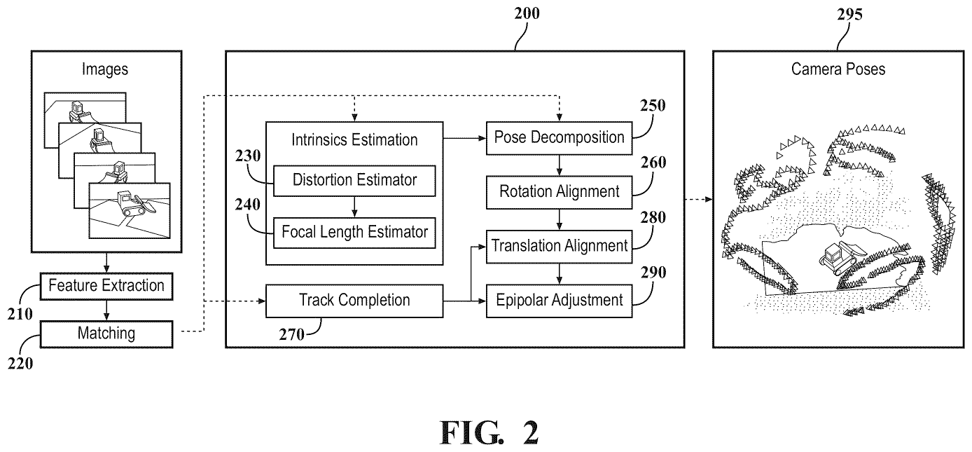

Now turning to FIG. 2, one embodiment of a pipeline 200 that is associated with estimating camera intrinsics and extrinsics with image data while reducing complexity is illustrated. The pipeline 200 may be integral with the estimation system 100 or the estimation system 100 is integral with the pipeline 200, as understood by one of ordinary skill in the art. The input to the pipeline 200 can be image data having one or more images from one of a single camera (e.g., a monocular camera), a camera-in-motion, or multiple cameras. Feature extraction 210 can involve identifying features and keypoints about a scene that a matching stage 220 matches. For instance, the estimation system 100 looks at local patches or areas within the image data that has corners, patterns, etc., and extracts features. An output of the matching stage 220 can have a set of inlier keypoint pairs and one of an estimated fundamental matrix Fᵢⱼ and a homography matrix Hᵢⱼ for an image pair (i,j) with enough correspondences. The homography matrix Hᵢⱼ may be utilized when consistent with sufficiently many inlier matches.

Computation by the pipeline 200 can include assumptions about a camera for estimating parameters. For instance, the pipeline 200 uses a distortion model as a one-parameter radial as explained below. Estimating the parameters can involve assuming that a principal point is fixed to a center point for deriving intrinsic parameters about the camera. Another assumption can be that images are taken with limited cameras and the pipeline 200 knows the images from the same camera. Furthermore, an association between the images and a camera can be inferred from image resolutions, exchangeable image file format (EXIF) tags, file names and directories, etc.

In various implementations, the intrinsic estimation by the pipeline 200 can involve assuming that images are generated according to a pinhole camera model. Other assumptions include parameterization by a 3×3 matrix K that is followed by radial distortion. In an example, estimation includes undistorting keypoints using a distortion estimate about a camera and estimating a focal length according to essential matrices. Here, the distortion estimator 230 can include finding distortion parameters that are consistent with a two-view geometric model for an image pair. For instance, an estimated fundamental matrix estimated from undistorted keypoints has the minimal epipolar error. Achieving this can include using an undistortion model exhibiting one-parameter division:

$${x}_{u} = \frac{{x}_{d}}{1 + α {r}_{d}^{2}} {y}_{u} = \frac{{y}_{d}}{1 + α {r}_{d}^{2}} . \qquad Equation ( 1 )$$

Here, (x_{d}, y_{d}) and (xᵤ, yᵤ) are the distorted and undistorted coordinates respectively,

$${r}_{d} = \sqrt{{x}_{d}^{2} + {y}_{d}^{2}} and {r}_{u} = \sqrt{{x}_{u}^{2} + {y}_{u}^{2}} ,$$

and α is the distortion model parameter. The model can be inverted in closed form for applying distortion to keypoints. In certain examples, closed-form models provide solutions and answers using a finite number of standard operations, making the models computationally efficient. These approaches offer clear insight into the behavior of mathematical models while avoiding iterative and numerical approximations that increase computational costs.

In another example, the distortion estimator 230 implements brute-force to predict and estimate the distortion parameter a. Knowing the distortion of one or more cameras allows downstream tasks such as object detection and tracking to adjust predictions for increasing accuracy. In certain examples, the distortion estimator 230 executes a line search as a low-dimensional problem that exhibits reduced complexity through finding one unknown parameter using many bunched valves on an interval basis and identifying a best value. In one approach, the pipeline 200 samples a set of candidate values from an interval [αₘᵢₙ, αₘₐₓ] given image pairs that share a same a. Here, the pipeline 200 also evaluates average epipolar errors for a candidate after undistorting and re-estimating fundamental matrices according to a sampled a. In an implementation, the process ignores homography matrices at this stage. Also, this approach can directly minimize an objective (e.g., an epipolar error) and account for information from multiple different image pairs, thereby improving noise robustness.

Distortion estimation can also involve evaluating candidate values independently, making the approach very parallelizable on a GPU. In yet another embodiment, the pipeline 200 utilizes hierarchical sampling and generalizations to images with different distortion parameters. A hierarchical search can accelerate the interval search by the distortion estimator 230 by scaling linearly with the number of candidates. In particular, the hierarchical search strategy iteratively shrinks the search interval. At each level of the hierarchy, the pipeline 200 sets the left and right candidates as the endpoints of the new interval for the next level after finding a solution. The solution at the last level is the estimate.

The distortion estimator 230 identifying distortion parameters for multiple cameras can encompass the following. If the two images in a pair have different intrinsic parameters, but the distortion parameter of one of the images is known, the distortion estimator 230 can implement a corresponding 1D searches and determine the distortion parameter of the other image. In this way, the distortion estimator 230 can extend the distortion estimation algorithm to handle multiple different cameras that correspond to a known subset of images. In another approach, an image pair is ready for a camera if either both images correspond to that camera; or only one of the images corresponds to that camera, but the distortion estimator 230 has already estimated the distortion parameter of the other image. This increases system robustness for the pipeline 200.

In various implementations, the pipeline 200 estimates the distortion parameters for multiple cameras one-by-one. Among the cameras whose distortion have not been estimated, the pipeline 200 may select the camera with the greatest number of ready image pairs. The distortion parameter for this camera is then estimated using these image pairs. This scenario can include modifying to the original algorithm (originally for a single image pair) where for each candidate of a computations involve the average epipolar error over all the point pairs among the ready image pairs. The pipeline 200 selects the next camera until the distortion parameters for the multiple cameras are completely estimated.

Computing accurate distortion parameters improves predictions by a focal length estimator 240 that uses undistorted keypoints and re-estimates the fundamental and homography matrices. In one approach, the focal length estimator 240 densely samples an interval. For instance, the focal length estimator 240 uses a 3×3 matrix as an essential matrix if singular values are such that λ₁=λ₂ and λ₃=0(λ₁≥λ₂≥λ₃). Given a correct fundamental matrix F and intrinsics matrix K, the essential matrix E=K^{T}FK should satisfy

$$\frac{{λ}_{1}}{{λ}_{2}} = 1 .$$

Therefore, if all images share the same intrinsics, given a set of fundamental matrices {Fᵢ}, the focal length estimator 240 can evaluate the accuracy of a candidate focal length ƒ using the singular value ratio above.

Letting

$${λ}_{1}^{( i )} \geq {λ}_{2}^{( i )} \geq {λ}_{3}^{( i )}$$

be the singular values of K^{T}FᵢK, where K is a function of ƒ, measuring the validity of ƒ encompasses:

$$v = {\sum }_{i} exp ( \frac{1 - \frac{{λ}_{1}^{( i )}}{{λ}_{2}^{( i )}}}{τ} ) , \qquad Equation ( 2 )$$

where τ is a temperature hyper-parameter. Here, a hyperparameter can be a fixed, external value set before optimization that influences the behavior of mathematical modeling. Equation(2) may be close to one when

$${λ}_{1}^{( i )} / {λ}_{2}^{( i )}$$

is close to one and decreases exponentially as

$${λ}_{1}^{( i )} / {λ}_{2}^{( i )}$$

increases.

In another example, the focal length estimator 240 can sample a candidate set of focal lengths and evaluate the set using Equation(2). Here, the candidate with the greatest value is chosen as the estimate. This approach can be generalized to deal with images having different focal lengths. After estimating the focal length, the pipeline 200 may transform the keypoints, fundamental matrices, and homography matrices using the estimated intrinsic matrices for calibration.

Moving onto the pose decomposition 250, this component can utilize estimated intrinsics (e.g., distortion, a focal length, etc.) to place the fundamental and homography matrices into relative rotations and translations. For example, a mathematical model decomposes relative pose using a set of keypoint matching between two images and intrinsics with closed-form solutions. In this way, the pipeline 200 improves efficiency when determining camera parameters while maintaining accuracy.

Global rotation by rotation alignment 260 can involve averaging for non-linear optimization to align global poses with local relative poses. Given a set of image pairs [symbol] ={(i,j)} and the corresponding relative rotation matrices [symbol] , the pipeline 200 can estimate a world-to-camera global rotation R⁽ⁱ⁾ matrix for image i. This can include optimization of a loss [symbol] when determining camera parameters that is defined over image pairs [symbol] ={(i,j)}:

$${ℒ}_{R} = \frac{1}{\vert 𝒫 \vert} {\sum }_{( i , j ) ∈ 𝒫} d ( {R}^{( j )} , {R}^{i \to j} {R}^{( i )} ) , \qquad Equation ( 3 )$$

where d(⋅,⋅) is the geodesic distance between rotations as defined by:

$$d ( R , {R}^{′} ) = {cos}^{- 1} ( \frac{Tr ( {R}^{T} {R}^{′} ) - 1}{2} ) . \qquad Equation ( 4 )$$

Parameterizing the global rotation matrices Rᵢ can involve using a differentiable 6D representation and optimizing Equation(3) with gradient descent. Gradient descent is an optimization algorithm for finding the minimum of a function by iteratively moving in the direction of a negative gradient. This helps minimize a function by updating parameters in small steps proportional to the slope (i.e., gradient) of the function at the current point. Parameterizing a matrix can involve expressing elements as functions of one or more variables (i.e., parameters). This allows the matrix to vary systematically with changing parameter values. In one approach, directly optimizing an objective from random initialization of Rᵢ and avoiding a local minima can involve assuming that although the column vectors in a rotation matrix are constrained by orthogonality, each column vector is subject to a unit length constraint. In another example, the pipeline 200 avoids these constraints by treating a column separately, solving for the values, and applying the constraints upon finding solutions.

In various embodiments, the rotation alignment 260 initializes the global rotation matrices for optimization by denoting a set of images as [symbol] and the set of image pairs as [symbol] = [symbol] . Here, every element has a relative rotation matrix R^{i→j}. The task is constructing a solution of global world-to-camera rotation matrices [symbol] that minimizes the objective. This differs from a final objective used in iterative optimization and can involve a L2 loss [symbol] as follows:

[symbol]

= [symbol] ∥R^{(j)}−R^{i→j}R⁽ⁱ⁾∥². Equation(5)

Directly solving this problem using a least squares approach may be unavailable when R⁽ⁱ⁾∈SO(3) are 3×3 matrices with orthogonality constraints. As such, the pipeline 200 can decompose the computation into several sub-problems and circumvent the constraints. In the following, A_{*,k} can denote the k^{th} column of a matrix A. Terms inside the summation in Equation (5) can be split into three parts:

$$ℒ = {\sum }_{( i , j ) ∈ 𝒫} {\sum }_{k = 1 , 2 , 3} {‖ {R}_{* , k}^{( j )} - {R}^{i \to j} {R}_{* , k}^{( i )} ‖}^{2} . \qquad Equation ( 6 )$$

Since RCM is an orthogonal matrix and the column vectors

$${R}_{* , k}^{( i )}$$

have unit length that exhibit mutually orthogonal. Looking at one particular column, say k=1, and ignoring the unit length constraint mitigates difficulties associated with orthogonality constraints. This allows the objective to become an unconstrained least squares problem:

$${ℒ}^{( 1 )} = {\sum }_{( i , j ) ∈ 𝒫} {‖ {R}_{* , 1}^{( j )} - {R}^{i \to j} {R}_{* , 1}^{( i )} ‖}^{2} . \qquad Equation ( 7 )$$

In various implementations, the pipeline 200 we can find a non-trivial solution that is non-zero with SVD. Since relative rotation matrices R^{i→j} are also orthogonal matrices, left multiplying with a vector preserves the vector length. This means that in a solution, the three-dimensional vectors

$${R}_{* , 1}^{( i )}$$

should have similar lengths. We can normalize the solution to unit length and get a solution of the actual first columns of global rotation matrices [symbol] .

Given already estimated first columns

$${\{ {R}_{* , 1}^{( i )} \}}_{i ∈ 𝒥}$$

of the global rotation matrices, the rotation alignment 260 can estimate the second columns by minimizing the same objective and/or adding additional constraints enforcing orthogonality to the first columns:

$${ℒ}^{( 2 )} = \frac{1}{\vert 𝒫 \vert} {\sum }_{( i , j ) ∈ 𝒫} {‖ {R}_{* , 2}^{( j )} - {R}^{i \to j} {R}_{* , 2}^{( i )} ‖}^{2} + \frac{1}{\vert 𝒥 \vert} {\sum }_{i ∈ 𝒥} {‖ {R}_{* , 1}^{( j )} {}^{⊤} {R}_{* , 2}^{( i )} ‖}^{2} , . \qquad Equation ( 8 )$$

Here, | [symbol] | is the number of image pairs and | [symbol] | is the number of images. These values are used heuristically for controlling the relative weighting of the two terms. In Equation(8),

$${R}_{* , 1}^{( i )}$$

are already fixed and the only free variables are

$$\{ {R}_{* , 2}^{( i )} \} .$$

This indicates a least squares problem that may be solved by applying SVD and then normalizing each 3D vector to a unit length. In an approach, the pipeline 200 utilizes a Gram-Schmidt process for enforcing the orthogonality between the first and second columns. In an implementation, the pipeline 200 can skip solving a least square problem again for the third columns because the values can be directly computed by taking the cross product of the first two columns:

$${R}_{* , 3}^{( i )} = {R}_{* , 1}^{( i )} \times {R}_{* , 2}^{( i )} . \qquad Equation ( 9 )$$

In this way, the pipeline 200 reduces computational complexity when computing global rotation matrices.

Regarding further details about the pipeline 200, in one approach the track completion 270 avoids bundle adjustment and data structures containing both 3D scene points and 2D keypoints that can increase complexity as follows. A graph can include 2D keypoints as nodes and pairwise edges denoting keypoint matches. When a 3D scene point is observed in m different images, the projected 2D keypoints should form a complete subgraph with m vertices. For instance, three of a same 3D point generate 3 point pairs, 4 observations generated 6 point pairs, and so on involving multiple observations by the pipeline 200.

In various examples, keypoint matching by the matching stage 220 has insufficient recall and misses certain point-pairs. Furthermore, a subgraph of related keypoints can be partially connected. Since pose estimation relies upon the number and quality of matches, the track completion 270 compensates for shortfalls by the matching stage 220 under certain circumstances. In an embodiment, a track is a connected component in a 2D keypoint connectivity graph that implies the existence of a shared 3D point. In one approach, the track completion 270 converts tracks to additional matches with pairwise combinations of keypoints in a track. For instance, the pipeline 200 merges point pairs between two images into a matrix having a compact form. This allows each image pair to be associated with a point pair, thereby improving efficiency. For example, each image pair is associated with a 9×9 matrix exhibiting complexity independent from the number of point pairs. The pipeline 200 can introduce additional point pairs after global rotation alignment and be inputted into translation alignment 280 and epipolar adjustment 290 for determining camera parameters. In this way, the pipeline 200 utilizes the transitivity of matching and benefit from extra constraints through tracking while avoiding the complexity from processing 3D points with point pairs.

Now discussing details involving the translation alignment 280, global translation may estimate 3D coordinates of camera centers in a common coordinate (e.g., world coordinate) frame, up to a similarity transformation. Global translation alignment may include the estimation system 100 predicting relative translations between image pairs. In one approach, the rotation alignment 260 estimates a global rotation that allows re-computing the relative rotation of any image pair. The relative rotation computed in this way can improve accuracy than approaches from relative pose decomposition. A better estimate of the relative rotation allows more accurately estimating relative translation by the translation alignment 280.

Moreover, the translation alignment 280 can estimate relative translation that benefits from new point pairs generated by the track completion 270. Here, the track completion 270 outputs image pairs originally lacking matches from the matching stage 220. In an example, the translation alignment 280 executes a 2D grid search and re-estimates the unit relative translation vectors. This can involve sampling a set of candidates on the surface of the unit sphere and evaluating the mean epipolar error from samples. The pipeline 200 and/or translation alignment 280 can select the candidate with the lowest error as the estimated global translation for a camera.

Mathematical and physical modeling for aligning global translation by the pipeline 200 can involve the following. Given world-to-camera rotations {Rᵢ}_{1≤t≤N} for N images and unit-length relative translations [symbol] for a set of image pairs [symbol] , the pipeline 200 computes a normalized vector from camera centers of image i to j in world coordinates:

$${o}^{i \to j} = - {R}_{j}^{⊤} {t}^{i \to j} . \qquad Equation ( 10 )$$

We estimate the camera locations {oᵢ}_{1≤i≤N} in the world frame by minimizing the error between the normalized relative translation

$$\frac{{o}_{j} - {o}_{i}}{{‖ {o}_{j} - {o}_{i} ‖}_{2}}$$

and the target o^{i→j} above with a gradient descent:

$${ℒ}_{t} = \frac{1}{\vert 𝒫 \vert} {\sum }_{( i , j ) ∈ 𝒫} {‖ \frac{{o}_{j} - {o}_{i}}{{‖ {o}_{j} - {o}_{i} ‖}_{2}} - {o}^{i \to j} ‖}_{1} . \qquad Equation ( 11 )$$

Optimizing the objective represented by Equation(11) allows accurate results using randomly initialized parameters. For reducing outliers from randomly initialized parameters, in one embodiment the pipeline 200 executes multiple independent runs from different random initializations and merges the solutions as the initialization for completing an optimization loop. When global rotations are similar, the pipeline 200 observes alignment between different solutions by moving the centroid to the origin and rescaling uniformly to have unit average norm. Here, a centroid can be a geometric center or average position of points in a shape or object (e.g., a center of mass for an object). In this way, the pipeline 200 selects a solution with the lowest average loss to be in a merged result for an image associated with a camera.

Regarding details involving the epipolar adjustment 290, the pipeline 200 can refine poses from a previous stage using re-weighting epipolar adjustment. This optimization exhibits computational complexity in an iteration that is linear in the number of image pairs rather than points. As such, the approach avoids computational complexity associated with bundle adjustment and similar processes for estimating camera parameters.

In relative translation re-estimation, the epipolar adjustment 290 acquires a set of image pairs with inliers above a certain threshold. The image pairs can be denoted as [symbol] ={(iₙ, [symbol] , where iₙ and jₙ are the indices of the first and second images in the pair. For an image pair (iₙ,jₙ)∈ [symbol] , we represent point pairs as

$${𝒬}_{n} = {\{ ( {x}_{nm}^{( 1 )} , {x}_{nm}^{( 2 )} ) ∈ {ℝ}^{2} \times {ℝ}^{2} \}}_{1 \leq m \leq \vert {𝒬}_{n} \vert} , and let {\tilde{𝒬}}_{n} = {\{ ( {\tilde{x}}_{nm}^{( 1 )} , {\tilde{x}}_{nm}^{( 2 )} ) ∈ {ℙ}^{2} \times {ℙ}^{2} \}}_{1 \leq m \leq \vert {\overline{𝒬}}_{n} \vert}$$

be the set of point pairs in normalized homogeneous coordinates.

Initialized using estimates from the previous stages, the pipeline 200 and/or epipolar adjustment 290 optimizes over the world-to-camera global rotations and translations to minimize the absolute epipolar error:

$${ℒ}_{e} = \frac{1}{Z} {\sum }_{n = 1}^{\vert 𝒫 \vert} {\sum }_{m = 1}^{\vert {\overline{𝒬}}_{n} \vert} \vert {\tilde{x}}_{nm}^{( 2 ) ⊤} {E}_{n} {\tilde{x}}_{nm}^{( 1 )} \vert . \qquad Equation ( 12 )$$

### Here,

$$Z = {\sum }_{n = 1}^{\vert 𝒫 \vert} \vert {\tilde{𝒬}}_{n} \vert$$

is the total number of point pairs, and Eₙ is the essential matrix computed from the global rotations and translations for images iₙ and jₙ. In Equation(12), replacing the cost terms with a L2 loss allows the overall objective to be re-organized during optimization of camera parameters by the pipeline 200. This can include aggregating terms involving point pairs shared by the same image pair that exhibits a compact quadratic form:

$${ℒ}_{e} = \frac{1}{Z} {\sum }_{n = 1}^{\vert 𝒫 \vert} {\sum }_{m = 1}^{\vert {\overline{𝒬}}_{n} \vert} {( {\tilde{x}}_{nm}^{( 2 ) ⊤} {E}_{n} {\tilde{x}}_{nm}^{( 1 )} )}^{2} = \frac{2}{Z} {\sum }_{n = 1}^{\vert 𝒫 \vert} {e}_{n}^{⊤} {W}_{n} {e}_{n} . \qquad Equation ( 13 )$$

Here, eₙ=flatten (Eₙ)∈ [symbol] , and Wₙ∈ [symbol] is a matrix computed from the point pairs in [symbol] . In one approach, eₙ is a function of the parameters to be optimized. The matrices Wₙ can be pre-computed for each image pair before optimization. In this way, the cost of optimization steps is linearly correlated with image pairs from the pre-computed Wₙ, thereby reducing computational complexity with the pipeline 200.

Under certain circumstances, Equation(13) is sensitive to outliers since the computation involves L2 losses during optimization. In an approach, an iterative re-weighted least squares (IRLS) computation improves robustness while preserving benefits of pre-computation associated with the loss function. Here, the pipeline 200 has a L1 loss that is robust to outliers, thereby allowing approximations of a weighted L2 loss with IRLS. That is, for some differentiable computed scalar value z, we have z²≈z²/|\hat{z}|, where \hat{z} is the value of z at initialization. In certain cases, the pipeline 200 has robust initialization of global poses after global translation alignment that allows computing the absolute epipolar error |\hat{ϵ}ₙₘ| for a point pair. The absolute epipolar error can weight the L2 loss to get an approximate and robust L1 loss:

$${\hat{ℒ}}_{e} = \frac{1}{Z} {\sum }_{n = 1}^{\vert 𝒫 \vert} {\sum }_{m = 1}^{\vert {\overline{𝒬}}_{n} \vert} \frac{{( {\tilde{x}}_{nm}^{( 2 ) ⊤} {E}_{n} {\tilde{x}}_{nm}^{( 1 )} )}^{2}}{\vert {\hat{ϵ}}_{nm} \vert} = \frac{2}{Z} {\sum }_{n = 1}^{\vert 𝒫 \vert} {e}_{n}^{⊤} {\hat{W}}_{n} {e}_{n} . \qquad Equation ( 14 )$$

Here, Ŵₙ is similar to Wₙ in Equation (13), but computed from \tilde{Q}ₙ weighted by |\hat{ϵ}ₙₘ|.

Following a round of optimization, the pipeline 200 can better approximate the L1 loss by re-computing the weights and trigger another optimization loop. For reducing the impact of outliers, the pipeline 200 periodically filters point pairs with an extensive epipolar error. In one approach, the pipeline 200 starts with an initial threshold that is substantial and gradually decreases the threshold to a pre-determined minimum. Such filtering can also optimize focal lengths associated with one or more cameras by incorporating them into the computation of the essential matrices that produce fundamental matrices.

Filtering can also improve the robustness of the rotation alignment 260 through removing image pairs having inlier point pairs that do not exceed a threshold. Here, a low threshold might introduce many outlier image pairs. A high threshold could reduce the number of connections and even disconnect the images into several clusters. In an implementation, the pipeline 200 commences from a large threshold and reduces the threshold by half if the action leads to disconnected clusters of detected points. The pipeline 200 iterates this approach until either all the images are connected or a minimal threshold is reached. In this way, the threshold is adaptive to the sensor data 150. When image data is still disconnected from others, the pipeline 200 can consider the images as outliers and ignore the image data in rotation alignment and later stages.

Deriving the following equivalent form of the L2 epipolar adjustment objective for epipolar adjustment can involve Equation(15):

$$ℒ = \frac{1}{Z} {\sum }_{n = 1}^{\vert 𝒫 \vert} {\sum }_{m = 1}^{\vert {\overline{𝒬}}_{n} \vert} {( {\tilde{x}}_{nm}^{( 2 ) ⊤} {E}_{n} {\tilde{x}}_{nm}^{( 1 )} )}^{2} = \frac{2}{Z} {\sum }_{n = 1}^{\vert 𝒫 \vert} {e}_{n}^{⊤} {W}_{n} {e}_{n} . \qquad Equation ( 15 )$$

Here, error terms are linear in the essential matrix. This allows rewriting terms as a dot product of a weight vector and a flattened version of the essential matrix:

$$\begin{matrix}ℒ & = \frac{1}{Z} {\sum }_{n = 1}^{\vert 𝒫 \vert} {\sum }_{m = 1}^{\vert {\overline{𝒬}}_{n} \vert} {( {\tilde{x}}_{nm}^{( 2 ) ⊤} {E}_{n} {\tilde{x}}_{nm}^{( 1 )} )}^{2} \\ & = \frac{1}{Z} {\sum }_{n = 1}^{\vert 𝒫 \vert} {\sum }_{m = 1}^{\vert {\overline{𝒬}}_{n} \vert} {( ( {\tilde{x}}_{nm}^{( 2 )} {\tilde{x}}_{nm}^{( 1 ) ⊤} ) ⊗ {E}_{n} )}^{2} \\ & = \frac{1}{Z} {\sum }_{n = 1}^{\vert 𝒫 \vert} {\sum }_{m = 1}^{\vert {\overline{𝒬}}_{n} \vert} {( {w}_{nm}^{⊤} {e}_{n} )}^{2}\end{matrix} . \qquad Equation ( 16 )$$

In Equation(16), the operation ⊗ is the element-wise multiplication operator,

$${w}_{nm} = flatten ( {\tilde{x}}_{nm}^{( 2 )} {\tilde{x}}_{nm}^{( 1 ) ⊤} ) ∈ {ℝ}^{9} ,$$

and eₙ=flatten(Eₙ)∈ [symbol] . Re-arranging the terms gets the summation having a set of quadratic forms:

$$\begin{matrix}ℒ & = \frac{1}{Z} {\sum }_{n = 1}^{\vert 𝒫 \vert} {\sum }_{m = 1}^{\vert {\overline{𝒬}}_{n} \vert} {( {w}_{nm}^{⊤} {e}_{n} )}^{2} \\ & = \frac{1}{Z} {\sum }_{n = 1}^{\vert 𝒫 \vert} {\sum }_{m = 1}^{\vert {\overline{𝒬}}_{n} \vert} {( {w}_{nm}^{⊤} {e}_{n} )}^{⊤} ( {w}_{nm}^{⊤} {e}_{n} ) \\ & = \frac{2}{Z} {\sum }_{n = 1}^{\vert 𝒫 \vert} {\sum }_{m = 1}^{\vert {\overline{𝒬}}_{n} \vert} {e}_{n}^{T} {w}_{nm} {w}_{nm}^{⊤} {e}_{n} \\ & = \frac{2}{Z} {\sum }_{n = 1}^{\vert 𝒫 \vert} {e}_{n}^{⊤} ( {\sum }_{m = 1}^{\vert {\overline{𝒬}}_{n} \vert} {w}_{nm} {w}_{nm}^{⊤} ) {e}_{n} \\ & = \frac{2}{Z} {\sum }_{n = 1}^{\vert 𝒫 \vert} {e}_{n}^{⊤} {W}_{n} {e}_{n}\end{matrix} . \qquad Equation ( 17 )$$

$$where {W}_{n} = {\sum }_{m = 1}^{\vert {\overline{𝒬}}_{n} \vert} {w}_{nm} {w}_{nm}^{⊤} ∈ {ℝ}^{9 \times 9} .$$

The pipeline 200 can output various camera parameters. In one approach, the pipeline 200 outputs a camera pose 295, a focal length, and a distortion parameter associated with a camera. Such values can be multiple when the camera is in motion or the pipeline 200 processes images data from multiple cameras. In an example, the focal length and the distortion parameter represent intrinsic parameters about a camera. Furthermore, the camera pose 295 comprises 3D rotation matrices and 3D translation vectors that can represent extrinsic parameters of a camera. In another approach, the output include a 3D point cloud that is sparse and identifies various camera parameters over time. Accordingly, the pipeline 200 efficiently estimates camera parameters through optimization that is time linear to image pairs and independent of 3D points that further improve speed while sustaining reliable scene reconstruction.

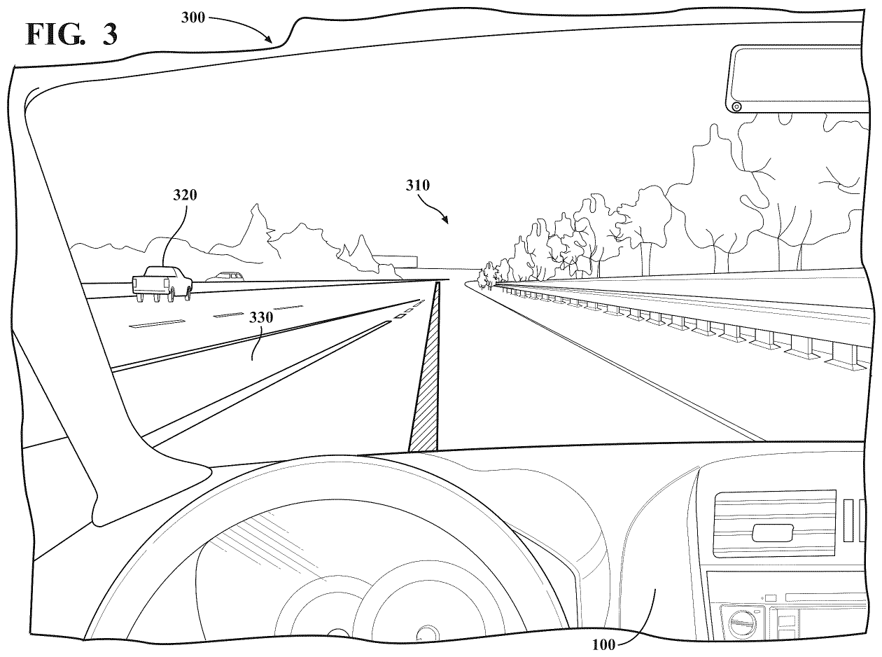

FIG. 3 illustrates one example of a vehicle 300 implementing the estimation system 100 to predict intrinsic and extrinsic parameters about a camera. Here, the vehicle 300 is traveling on a road 330 having a truck 320 within the vehicle environment 310. The vehicle 300 implements the estimation system 100 to perceive the truck 320 while merging. The estimation system 100 outputs the intrinsic parameters 160 and camera poses as extrinsic parameters about a camera with increased accuracy and efficiency. This allows downstream systems such as a machine learning model to reliably detect features about the truck 320. For example, the ML model estimates a real-world distance to the truck 320 for motion planning by the vehicle 300. Accordingly, the estimation system 100 improves the operation and safety of the vehicle 300

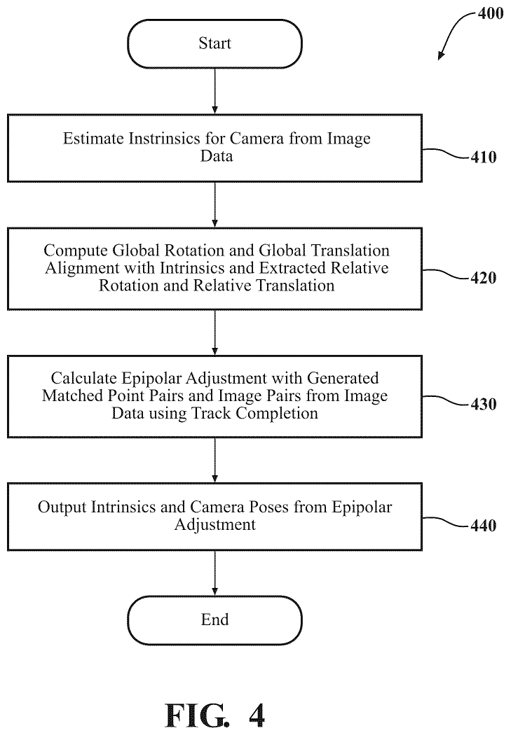

Now regarding FIG. 4, one embodiment of a method 400 that is associated with estimating intrinsics and poses about a camera using global alignment, track completion, and epipolar adjustment is illustrated. The method 400 will be discussed from the perspective of the estimation system 100 of FIG. 1. While the method 400 is discussed in combination with the estimation system 100, it should be appreciated that the method 400 is not limited to being implemented within the estimation system 100 but is instead one example of a system that may implement the method 400.

At 410, the estimation system 100 derives and estimates the intrinsic parameters 160 for a camera from image data. Here, the focal length and the distortion parameter can represent the intrinsic parameters 160 about a camera and the image data is associated with the sensor data 150. Deriving intrinsic camera parameters prior to extrinsic camera parameters can reduce computational costs and complexity. In an example, estimating the intrinsic parameters 160 involves undistorting keypoints derived from the image data using an estimate of the distortion parameter from a geometric model. Here, the geometric model utilizes interval searching that includes hierarchical sampling for the distortion parameter. This allows predicting the focal length using an essential matrix derived from interval sampling. Furthermore, the estimation system 100 transforms the keypoints, the fundamental matrix, and the homography matrix with the intrinsic parameters 160 for identifying values. As previously explained, the estimation system 100 can execute line search as a low-dimensional problem through finding one unknown parameter using many bunch valves on an interval basis and identifying a best value. Sampling a set of candidate values from an interval given a set of image pairs that share a same a can help the estimation system 100 to rapidly find the distortion parameter.

Moreover, predicting the focal length of a camera from the image data can involve sampling a candidate set of focal lengths and evaluating the set. In an embodiment, the candidate with the greatest value is chosen as the estimate. As previously described, this approach can be generalized to deal with images having different focal lengths, thereby exhibiting system robustness.

At 420, the estimation system 100 and/or the identification module 130 computes a global rotation and a global translation alignment with the intrinsics and extracted relative rotation and relative translation. Finding a global rotation value can involve averaging for non-linear optimization to align global poses with local relative poses. As previously described, the estimation system 100 may parameterize the global rotation matrices using differentiable representations and optimizing with a gradient descent. In one approach, directly optimizing an objective from random initialization and avoiding a local minima can involve assuming that although the column vectors in a rotation matrix are constrained by orthogonality, each column vector is subject to a unit length constraint. As such, considering a column at a time allows the formulating the global rotation optimization as a least squares problem and solving using SVD, thereby reducing complexity.

Global translation may involve estimating 3D coordinates of camera centers in a common coordinate (e.g., world coordinate) frame, up to a similarity transformation. Global translation alignment may include the estimation system 100 predicting relative translations between image pairs. In one approach, rotation alignment involves estimating a global rotation that allows re-computing the relative rotation of any image pair. The relative rotation computed in this way can improve accuracy than approaches from relative pose decomposition. An improved estimate of the relative rotation allows more accurate estimates for relative translation.

As previously described, translation alignment involves estimating a relative translation that benefits from new point pairs generated by the track completion. Here, track completion includes image pairs from one or more cameras originally lacking matches from keypoint matching. For instance, the estimation system 100 executes translation alignment with a 2D grid search and re-estimates the unit relative translation vectors.

At 430, the estimation system 100 calculates an epipolar adjustment with generated matched point pairs and image pairs from image data using track completion. In this example, a point pair is two corresponding keypoints in different images from a same camera that represent the same physical point in the scene. An image pair is a pair of images captured from the camera having different viewpoints or times. A track can be a connected component in the 2D keypoint connectivity graph and implies the existence of a shared 3D point. In an example, the estimation system 100 converts tracks to additional matches with pairwise combinations of keypoints in a track. For instance, the estimation system 100 merges point pairs between two images into a matrix having a compact form so that each image pair is associated with a point pair, thereby improving system performance and efficiency.

Epipolar adjustment can involve refining poses from a previous stage using re-weighting. This optimization exhibits computational complexity in an iteration that is linear in the number of image pairs rather than points. In one approach, the estimation system 100 involves relative translation re-estimation where the epipolar adjustment acquires a set of image pairs with inliers above some threshold. Initialized using estimates from the previous stages, the estimation system 100 optimizes over the world-to-camera global rotations and translations to minimize the absolute epipolar error. As such, epipolar adjustment and/or tracking can jointly refine the focal length and the camera poses. This allows the estimation system 100 to output accurate and fast camera poses and the intrinsic parameters 160 associated with the epipolar adjustment while reducing optimization complexity through avoiding computations over 3D points.

At 440, the estimation system 100 outputs the intrinsic parameters and camera poses associated with the epipolar adjustment. This output can include a camera pose, a focal length, and a distortion parameter associated with a camera or multiple cameras. Such values can be multiple when the camera is motion or the estimation system 100 processes image data from the multiple cameras. In an example, the focal length and the distortion parameter represent intrinsic parameters about a camera. Meanwhile, the camera pose can include a 3D rotation matrix and a 3D translation vector representing extrinsic parameters of a camera. As previously explained, the output can also include a 3D point cloud that is sparse and identifies various camera parameters over time. Accordingly, the pipeline 200 efficiently estimates camera parameters through optimization that is time linear to image pairs for promoting GPU acceleration while estimating reliable scene reconstruction for downstream tasks (e.g., object classification, distance estimates, etc.).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An estimation system comprising:
a memory storing instructions that, when executed by a processor, cause the processor to:
estimate intrinsic parameters for a camera from image data and derive a distortion parameter and a focal length;
compute a global rotation alignment and a global translation alignment for the camera with the intrinsic parameters, an extracted relative rotation, and an extracted relative translation;
calculate an epipolar adjustment with generated matched point pairs and image pairs from the image data using track completion and the global translation alignment; and
output the intrinsic parameters and camera poses associated with the epipolar adjustment.

2. The estimation system of claim 1 further including instructions to:
extract keypoints from the image data, the keypoints identify features of an object within the image data and the features are one of corners and edges;
match the keypoints to derive keypoint pairs and a matrix for an image pair from the image data, wherein the matrix is one of an estimated fundamental matrix and a homography matrix about the image pair; and
predict the camera poses with the intrinsic parameters, the keypoint pairs, and the matrix.

3. The estimation system of claim 2 further including instructions to:
derive the extracted relative rotation and the extracted relative translation for the image pair; and
generate a point pair from the keypoint pairs and the matrix using the track completion.

4. The estimation system of claim 3, wherein the instructions to calculate the epipolar adjustment further include instructions to:
re-weight the camera poses using a least squares function with the point pair and a L2 loss, wherein the L2 loss is associated with previous values of the focal length and the camera poses;
compute an epipolar error for the point pair;
weight the L2 loss with the epipolar error to derive a L1 loss.

5. The estimation system of claim 2, wherein the instructions to estimate the intrinsic parameters further include instructions to:
undistort the keypoints using an estimate of the distortion parameter from a geometric model, wherein the geometric model utilizes interval searching that includes hierarchical sampling for the distortion parameter;
predict the focal length using an essential matrix derived from interval sampling; and
transform the keypoints, the fundamental matrix, and the homography matrix with the intrinsic parameters.

6. The estimation system of claim 2, wherein the instructions for the track completion further include instructions to:
convert tracks to multiple matches using pairwise combinations of the keypoints associated with a first track, wherein the keypoints are two-dimensional (2D) keypoints and the multiple matches are associated with a three-dimensional (3D) scene point in multiple images that are different; and
assemble a complete graph with the 2D keypoints, wherein nodes of the complete graph are the 2D keypoints and edges are the multiple matches.

7. The estimation system of claim 6, wherein the instructions to compute the global rotation alignment and the global translation alignment further include instructions to:
adjust relative translations between image pairs for the global translation alignment associated with the global rotation alignment and the complete graph.

8. The estimation system of claim 1, wherein the instructions to compute the global rotation alignment and the global translation alignment further include instructions to:
derive the global rotation alignment using a singular value decomposition (SVD) of a rotation matrix column-by-column.

9. The estimation system of claim 1, wherein the camera poses include a three-dimensional (3D) rotation matrix and a 3D translation vector and the camera poses are extrinsic parameters associated with the camera.

10. A non-transitory computer-readable medium comprising:
instructions that when executed by a processor cause the processor to:
estimate intrinsic parameters for a camera from image data and derive a distortion parameter and a focal length;
compute a global rotation alignment and a global translation alignment for the camera with the intrinsic parameters, an extracted relative rotation, and an extracted relative translation;
calculate an epipolar adjustment with generated matched point pairs and image pairs from the image data using track completion and the global translation alignment; and
output the intrinsic parameters and camera poses associated with the epipolar adjustment.

11. The non-transitory computer-readable medium of claim 10, further include instructions to:
extract keypoints from the image data, the keypoints identify features of an object within the image data and the features are one of corners and edges;
match the keypoints to derive keypoint pairs and a matrix for an image pair from the image data, wherein the matrix is one of an estimated fundamental matrix and a homography matrix about the image pair; and
predict the camera poses with the intrinsic parameters, the keypoint pairs, and the matrix.

12. A method comprising:
estimating intrinsic parameters for a camera from image data and deriving a distortion parameter and a focal length;
computing a global rotation alignment and a global translation alignment for the camera with the intrinsic parameters, an extracted relative rotation, and an extracted relative translation;
calculating an epipolar adjustment with generated matched point pairs and image pairs from the image data using track completion and the global translation alignment; and
outputting the intrinsic parameters and camera poses associated with the epipolar adjustment.

13. The method of claim 12 further comprising:
extracting keypoints from the image data, the keypoints identify features of an object within the image data and the features are one of corners and edges;
matching the keypoints to derive keypoint pairs and a matrix for an image pair from the image data, wherein the matrix is one of an estimated fundamental matrix and a homography matrix about the image pair; and
predicting the camera poses with the intrinsic parameters, the keypoint pairs, and the matrix.

14. The method of claim 13 further comprising:
deriving the extracted relative rotation and the extracted relative translation for the image pair; and
generating a point pair from the keypoint pairs and the matrix using the track completion.

15. The method of claim 14, wherein calculating the epipolar adjustment further includes:
re-weighting the camera poses using a least squares function with the point pair and a L2 loss, wherein the L2 loss is associated with previous values of the focal length and the camera poses;
computing an epipolar error for the point pair;
weighting the L2 loss with the epipolar error to derive a L1 loss.

16. The method of claim 13, wherein estimating the intrinsic parameters further includes:
undistorting the keypoints using an estimate of the distortion parameter from a geometric model, wherein the geometric model utilizes interval searching that includes hierarchical sampling for the distortion parameter;
predicting the focal length using an essential matrix derived from interval sampling; and
transforming the keypoints, the fundamental matrix, and the homography matrix with the intrinsic parameters.

17. The method of claim 13, wherein the track completion further includes:
converting tracks to multiple matches using pairwise combinations of the keypoints associated with a first track, wherein the keypoints are two-dimensional (2D) keypoints and the multiple matches are associated with a three-dimensional (3D) scene point in multiple images that are different; and
assembling a complete graph with the 2D keypoints, wherein nodes of the complete graph are the 2D keypoints and edges are the multiple matches.

18. The method of claim 17, wherein computing the global rotation alignment and the global translation alignment further includes:
adjusting relative translations between image pairs for the global translation alignment associated with the global rotation alignment and the complete graph.

19. The method of claim 12, wherein computing the global rotation alignment and the global translation alignment further includes:
deriving the global rotation alignment using a singular value decomposition (SVD) of a rotation matrix column-by-column.

20. The method of claim 12, wherein the camera poses include a three-dimensional (3D) rotation matrix and a 3D translation vector and the camera poses are extrinsic parameters associated with the camera.
